(19) United States
(12) Patent Application Publication
(10) Pub. No.: US 2025/0369481 A1
(43) Pub. Date: Dec. 4, 2025

(54) LOW NOISE COMPOSITE MATERIAL ROLLING BEARING CAGE AND ASSOCIATED ROLLING BEARING UNIT AND METHOD

(71) Applicants: AKTIEBOLAGET SKF, GOTEBORG (SE); SKF Aerospace France S.A.S, Perrigny (FR)

(72) Inventors: Hari Shankar VADIVEL, Nieuwegein (NL); Anthony Roger Jeannot JÉRÔME, Valence (FR); Valentin Roger Claude FLEURY, Romans-sur-Isère (FR); Thomas Bernd KRAUSE, Grafenrheinfeld (DE)

(21) Appl. No.: 19/211,378

(22) Filed: May 19, 2025

(30) Foreign Application Priority Data
May 29, 2024 (IT) 102024000012283

(51) Int. Cl. F16C 33/44

(52) U.S. Cl. CPC F16C 33/44

(57) ABSTRACT

A low noise composite material rolling bearing cage formed by a method that includes providing an annular body having a plurality of through openings each configured to receive a rolling body, the annular body comprising epoxy resin and a plurality of embedded and superimposed layers of continuous reinforcing fibers in the epoxy resin, the epoxy resin having a glass transition temperature greater than or equal to 90° C., and subjecting the annular body of epoxy resin to a burr-removing tumbling operation. Also a related method.

### CROSS-REFERENCE

This application claims priority to Italian patent application no. 102024000012283 filed on May 29, 2024, the contents of which are fully incorporated herein by reference.

### TECHNOLOGICAL FIELD

The present disclosure relates to a low noise rolling bearing cage obtained in a fiber reinforced composite synthetic plastic material and to an associated rolling bearing unit and method of manufacturing.

### BACKGROUND

As it is well known, a rolling bearing unit comprises a rolling bearing having an outer ring, an inner ring and a plurality of rolling bodies (for example balls) interposed between the inner and outer rings to make them relatively rotatable with low friction, and a rolling bearing cage to retain the rolling bodies in position, the cage being arranged in the radial space delimited between the inner ring and the outer ring.

A rolling bearing retaining cage comprises an annular body delimited between a radially inner and outer cylindrical surface and a plurality of pockets or seats, each configured to house and retain in a freely rotatable manner a respective rolling body of the rolling bearing. The cage body is generally made of a synthetic plastic material, for example a phenolic resin or a polyamide or other suitable synthetic materials, and includes the pockets or seats, which are provided radially therethrough in the form of radial through-holes.

To form a bearing case, a preform comprising a hollow tube is obtained by molding the synthetic material and then the hollow tube is cut radially into a plurality of slices, each one constituting a cage body. Before or after the cutting operation the pockets or seats are drilled through the cage body.

To improve performance, it is also known to form the cage body from a fiber-reinforced synthetic material, e.g. phenolic resins reinforced with cotton fibers embedded in the synthetic material matrix. More recently, it has been proposed to make fiber reinforced polymer cages out of an epoxy resin reinforced with high tensile strength fibers, like carbon fibers, glass fibers and the like.

In this case, the hollow tube constituting the preform may be produced by a process known as “continuous filament winding” (CFW), by tightly winding on a metal mandrel one or more filaments of composite material consisting in continuous fibers impregnated with a synthetic plastic resin.

Here and in the following, for “plastic resin” it is to be understood either a thermoset or thermoplastic synthetic material, e.g., impregnation of fibers can either be made by a liquid thermoset resin or by a solid thermoplastic powder.

After a prefixed number of superimposed radial layers of pre-impregnated fibers are obtained, the preform is cured in a known manner to cause the consolidation of the synthetic material impregnating the fibers in a solid matrix, in which the winded fibers remain embedded to constitute a reinforcing material. Curing may occur as disclosed, e.g., in FR 3053624 A1.

Polymer based cages like those as described above tend to rattle in use, especially when employed in rolling bearings servicing machine tool applications and more specifically under specific operating conditions. For example, at specific RPMs (revolutions per minute), rattling can be significant. Rattling is a noise which is degrading the rolling bearing quality perceived by the user of a vehicle in which such cages are used and generates in any case an extremely annoying rattling noise.

Recent tests shown that also the fiber-reinforced synthetic material cages made of carbon fiber reinforced epoxy resin, though being superior in many aspect to the traditional cotton fiber reinforced phenolic cages, suffer from the rattling problem. These kind of polymer cages, in addition to generating undesired noises, also may exhibit delaminated layers and loose particles inside the rolling bearing which may impair the performance and operating life of the cage itself and of the rolling bearing in general.

### SUMMARY

An aspect of the present disclosure is to overcome the drawbacks of the prior art by providing a composite material rolling bearing cage having an improved service life and preserving the mechanical properties of the cage in all use conditions. It is moreover an aspect of the disclosure to provide a composite material rolling bearing cage exhibiting no or dramatically reduced rattling behavior under all operative conditions and no, or extremely reduced, presence of delaminated layers and loose particles consequent to even high rotational speed and high loads, as well as a method of manufacture such a rolling bearing cage.

It is also an aspect of the disclosure to provide a high precision rolling bearing unit equipped with a CFW composite material cage able to be employed in particularly stressful applications, like those requiring high rotation speeds and/or subjected to high loads and high temperatures.

According to the disclosure, there are provided a composite material rolling bearing cage having improved mechanical behavior and an associated rolling bearing unit and method, as defined in the appended claims.

### BRIEF DESCRIPTION OF THE DRAWINGS

Further characteristics and advantages of the present disclosure will become clear from the following description of non-limiting examples thereof, carried out with reference to the Figures of the attached drawings, in which:

FIG. 1 is a side elevational view, partly in section, of a rolling bearing unit having a bearing cage according to an embodiment of the disclosure.

FIG. 2 is a perspective view of the bearing cage of FIG. 1.

FIG. 3 is a schematic perspective view of a preform tube mounted on a mandrel from which the retaining cage of FIG. 2 may be obtained.

### DETAILED DESCRIPTION

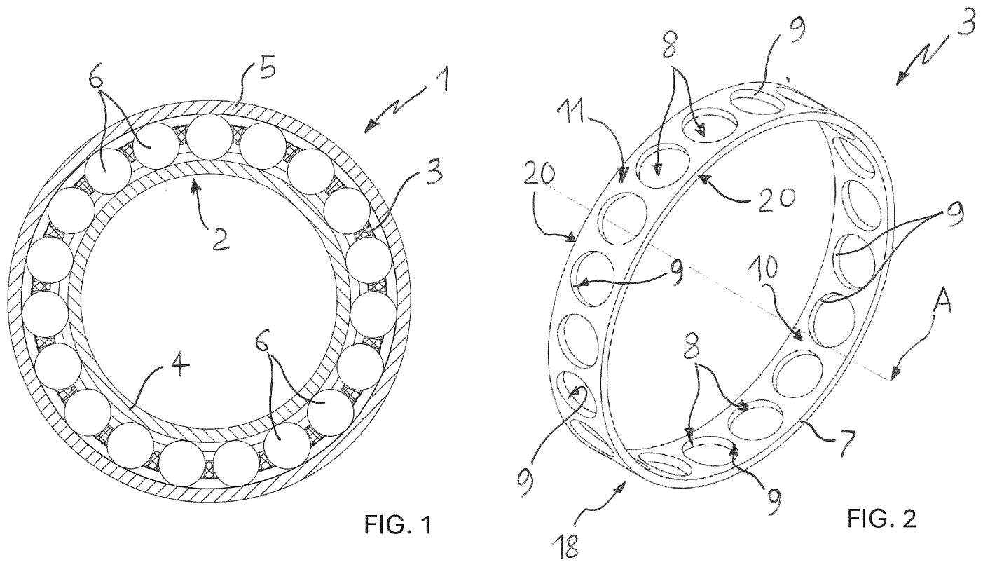

With reference to Figures from 1 to 3, the reference number 1 indicates a rolling bearing unit (FIG. 1) comprising a rolling bearing 2 of any known type and a rolling bearing cage 3, made of a composite material. The rolling bearing comprises an inner ring 4, an outer ring 5 and a plurality of rolling elements or bodies 6, in the non-limiting embodiment shown consisting of balls.

The rolling bodies 6 are arranged, in the example shown, in one row of balls around an axis of symmetry A of the rolling bearing, which is also the axis of symmetry of cage 3. In different embodiments, not shown for sake of simplicity, the rolling bearing 2 may comprise two rows of rolling bodies arranged side by side and the rolling bodies may be without limitation, balls, cylindrical or conical rolls, small cylinders, according to the operation necessity.

In any case, the rolling bearing cage 3 (FIG. 2) comprises an annular body 7 and a plurality of pockets or seats 8, each configured to freely house in use a respective rolling body 6 of the rolling bearing 2 to correctly keep the rolling bodies 6 spaced apart to each other by a prefixed pitch; each pocket or seat is delimited by a peripheral edge 9.

The annular body 7 has an axis of symmetry A and a predetermined axial width or length. The pockets or seats 8 are provided radially throughout the annular body 7, through radially inner and outer cylindrical surfaces 10 and 11 (FIG. 2) of the annular body 7, substantially perpendicularly thereto. In the example shown, the pockets 8 comprise simple cylindrical radial holes. The cylindrical surfaces 10 and 11 radially delimit the annular body 7 therebetween.

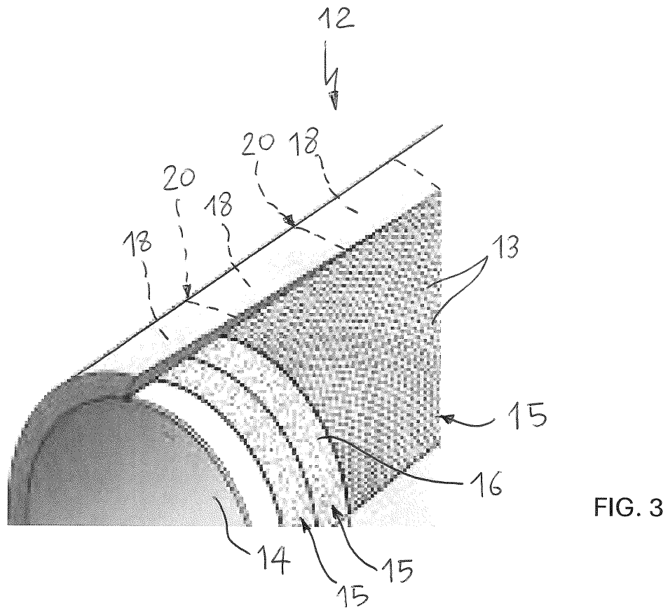

The annular body 7 is made of a fiber-reinforced synthetic plastic material comprising a plurality of superimposed layers 15 of high tensile strength fibers 13, like e.g., carbon fibers, impregnated with a synthetic resin, e.g., an epoxy resin, and is preferably obtained by a method known in the art as continuous filament winding (CFW), by firstly obtaining a preform tube 12 (FIG. 3), schematically shown in a non-limitative manner, merely for illustrative purposes and for a better understanding of the disclosure.

With reference to FIG. 3, in a CFW production method a plurality of reinforcing fibers 13 are impregnated in known manner with a synthetic plastic resin/material comprising e.g., an epoxy resin and are then wound around a mandrel 14 with a prefixed inclination or angle with respect to the axis of symmetry A of the final cage 3, up to obtain the preform tube 12. In alternative, pre-peg (pre-impregnated) fibers or sheets of neatly ordered fibers may be used.

Then, a plurality of annular bodies 7 are obtained from a single preform tube 12, after having cured the latter in any known and suitable manner (e.g. according to FR 3053624 A1), in order to polymerize the epoxy resin impregnating the fibers 13 to form a solid matrix 16, by cutting radially it in slices constituted each by an axial segment 18 of the preform tube 12, cut away in a radial direction, e.g., along the dotted lines (FIG. 3), such as each axial segment 18 of the preform tube 12 has the same axial width/length of a cage 3 to be obtained.

Before or after the cutting step, but generally after the curing step, a plurality of radial holes configured to form the pockets or seats 8 are drilled through each axial segment 18 of the preform tube 12. In alternative, the pockets or seats 8 may be obtained, still in known manner, during e.g., the winding by properly arranging the axial position of the fibers 11b and by providing the mandrel 14 with a plurality of radially outstanding pins (not shown) each configured to form a hole corresponding to a pocket or seat 8.

The continuous filament winding technique allows for a continuity of the fibers all along the circumference of the cage and helps to improve the stiffness, the strength and the dimensional stability of the cage.

The annular body 7 of a cage 3 according to the disclosure, therefore, comprises a plurality of superimposed layers 15 of reinforcing fibers 13 embedded in a synthetic resin, preferably an epoxy resin, and arranger with respect to the axis of symmetry A according to a prefixed pattern.

After the cutting step, each segment 18 forming a respective cage body 7 remains delimited axially by two opposite axial frontal edges 20 (FIGS. 2 and 3).

In some embodiments, the preform tube 12 may be obtained either in a polymerized fiber reinforced thermoset rein or in a polymerized thermoplastic resin. In this latter case, the curing step of the preform tube 15 would be no longer necessary, since the thermoplastic powder for impregnating/embedding the fibers needs to be melted (and thus also polymerized) directly on the mandrel 14, e.g., by a laser beam or by a flux of hot air.

According to an aspect of the disclosure, in combination with forming the cage body 7 from radially superimposed layers 15 of high strength reinforcing fibers 13 embedded in/impregnated by a synthetic resin having a glass transition temperature equal to or higher than 90° C., preferably 120° C., and preferably comprising an epoxy resin, the inner and outer cylindrical surfaces 10,11 of the annular cage body 7, the peripheral edge 9 of each pocket or seat 8 and opposite axial frontal edges 20 of the annular body 7 show a deburring finishing, namely show substantially no burrs, since, according to an aspect of the disclosure, the whole cage 3 according to the disclosure, after obtaining the annular cage body 7 completed with the necessary number of pockets or seats 8, has been subjected to a tumbling process/operation.

Tumbling is a well-known technique and involves submitting the parts to be tumbled to vibration while in the presence of an abrasive media, like e.g., small stones, pebbles or ceramic particles, which process in technical terms is also known as “vibratory finishing”. The abrasive media is specially designed to cause friction with the parts to be tumbled so as to have the effect of polishing the parts to be tumbled in a controlled manner. In an embodiment of the present disclosure, the parts to be tumbled are a suitable number of the cages 3/

There are established parameters, well known to the skilled in the art and therefore not disclosed herein for sake of simplicity, governing the mixture of media and elements to be tumbled, and the amount of time the elements to be tumbled remain in the tumbler, depending on the material, dimension and shape of the elements, as well as on the kind of machine (tumbler) employed.

Tumbling is carried out in a vibratory tumbler, which comprises a large doughnut-shaped drum with parts that rotate in a circular direction while the drum shakes at a high speed. This causes the tumbling media and parts to be worked to scrub against each other abrading the parts under process and removing burrs that may be present. After a proper amount of time, the tumblers are emptied into a conveyor belt and the parts/product tumbled are sent through a cleaner and dryer. The tumbling process is usually performed after each production process that causes burrs, or after heat treating in case of metal parts, where black scale resides on the parts and must be removed.

In general, the amount of material that may be removed in a tumbling process may be in some instances, up to 0.0005 inches, e.g. using appropriate vibratory media and an extended finishing time. Generally, this is a cost effective method of obtaining smooth product within given tolerances and dimensions compared to other machine removal, such as milling or grinding. Removal is uniform, but may be not precise on all parts of the treated surfaces, which renders the use of such surface finishing method quite identifiable, merely looking at the finished product.

However, contrary to what is known in the art, in the case of the present disclosure, tumbling is not carried out merely as a surface finishing process, but for another specific and new purpose.

Investigations carried out by the present Applicant, in fact, showed that, when the specific composite material disclosed above, i.e., high tensile strength fibers impregnated of/embedded in a synthetic plastic resin having a glass transition temperature of at least 90° C., preferably 120° C., are used to obtain a rolling bearing cage, the tendency of the cage to be subjected to rattling in use is surprisingly suppressed or almost suppressed.

Accordingly, tumbling is used, according to the present disclosure, to solve the problem of rattling, the effect of surface finishing the cage 3 being to be considered only a secondary effect.

This surprising result, however, is present only when a specific composite material for the cage 3 is selected, namely a high strength and stiff fiber reinforced synthetic plastic resin having a glass transition temperature equal to or higher than 90° C., preferably 120° C., and comprising preferably but not exclusively in an epoxy resin.

According to a further feature of the disclosure, the reinforcing fibers 11 are selected from the group consisting of: carbon fibers, glass fibers, Kevlar® fibers, ceramic and metal and biobased fibers any synthetic fiber similar thereto for tensile strength and stiffness. In some embodiments, the reinforcing fibers may comprise mineral fibers like basalt and quartz fibers and also in ceramic fibers, like Al₂O₃ or SiC fibers and even in metal fibers like steel or aluminum fibers. In some embodiments, the reinforcing fibers may consist in other organic fibers like cotton, cellulose, flax, jute, hemp and sisal fibers.

According to a preferred embodiment, the reinforcing fibers 13 are continuous fibers embedded in/impregnated by the aforementioned synthetic resin and wound around the axis of symmetry A according to predetermined winding angles.

According to one aspect of the disclosure, the rolling bearing unit 1 in FIG. 1 comprises therefore a rolling bearing, e.g., the rolling bearing 2 or any other model of rolling bearing having a plurality of rolling bodies 6 arranged in a radial space delimited between the inner ring 4 and the outer ring 5 to render them relatively rotatable with low friction, and a rolling bearing cage 3 as described above for retaining the rolling bodies 6 spaced apart. The rolling bearing 2 is preferably of the high precision bearing type, characterized by high speed and/or high load of operation.

From what disclosed above, it is clear, moreover, that the present disclosure extends to a method for producing a composite material rolling bearing cage 3 comprising an annular body 7 and a plurality of pockets or seats 8, each configured to house in use a respective rolling body 6 of a rolling bearing 2, the annular body 7 having an axis of symmetry A and a prefixed axial width and the pockets or seats 8 being provided radially throughout the annular body 7, through respective inner and outer cylindrical surfaces 10,11 of the annular body 7 radially delimiting the same, the pockets or seats being delimited by respective peripheral edges 9 thereof, the method comprising the steps of: a) producing a preform tube 12 made of fiber reinforced synthetic plastic material wherein the fibers are made of a high tensile strength and stiff material impregnated with a synthetic resin having a glass transition temperature equal to or higher than 90° C., preferably 120° C.; b) curing the preform tube 12 in order to polymerize the synthetic plastic material to form a consolidated synthetic plastic matrix 15 in which the reinforcing fibers 13 are embedded according to a predetermined pattern; c) radially cutting from the preform tube a plurality of axial segments 18 thereof, each having an axial width identical to that of the rolling bearing cage 3 to be obtained, each axial segments 18 of the preform tube 15 having a plurality of pockets or seats 8 provided therethrough and configured to house in use rolling bodies 6 of a rolling bearing 2, the pocket or seats 8 being obtained during step a) or being drilled in the preform tube 12 after step b); and d) after step c) subjecting the whole cages 3, obtained by cutting the preform tube 12 in a plurality of axial segments 18 and by providing therethrough the pockets or seats 8, to a tumbling step or process, to substantially eliminate any burr from the radially inner and outer lateral cylindrical surfaces 10,11, as well as from the peripheral edges 9 of the pockets or seats 8 and from respective opposite axial frontal edges 20 of each cage body 7.

According to a preferred embodiment of the method of the disclosure, the synthetic plastic material is an epoxy resin. According to a preferred embodiment of the method of the disclosure, the fibers 13 are selected from the group consisting of: carbon fibers, glass fibers, Kevlar® fibers, mineral fibers like basalt and quartz fibers, ceramic fibers, e.g., Al₂O₃ or SiC fibers, metal fibers, e.g., steel or aluminum fibers, organic fibers including cotton, cellulose, flax, jute, hemp and sisal fibers, any synthetic, organic or inorganic fiber similar thereto in tensile strength and stiffness.

According to a preferred embodiment of the method of the disclosure, the preform tube 12 is obtained by a continuous filament winding technique, by winding on a mandrel 14 having an axis of symmetry coinciding with the axis of symmetry A of the rolling bearing cage 3 to be obtained, at least one continuous fiber 13 made, as already disclosed, of a high tensile strength and stiff material impregnated with a synthetic resin having, after curing, a glass transition temperature greater than or equal to 90° C., preferably 120° C., to form a plurality of radially superimposed layers 15 of impregnated reinforcing fibers 13.

The tumbling step is carried out in a vibrating tumbler machine, loaded with a (suitable) number of identical complete cage bodies 7 mixed with abrasive particles having a dimension of at least one order of magnitude lower than an outer diameter of the cage body 7, namely of the outer lateral surface 11. The abrasive media may consist preferably in small pebbles and/or ceramic particles.

The present disclosure is now further disclosed according to the following working example.

### Example 1

Sixty cages 3 as discloses with reference FIGS. 2 and 3 are produced using the same material, namely carbon fibers impregnated with an epoxy resin and as disclosed herein above.

In a tumbling machine of the producer Levi Tunisi, model LT VBT 600L, having a useful capacity: 560 L and total power of 5.5 kW, twenty of the produced cages 3 are mixed randomly with an abrasive media consisting in ⅛″ Ceramic Tumbling product marketed by the company GANGOU.

Operating according to the machine instructions for tumbling polymer products, the twenty cages are tumbled. At the end of the tumbling cycle, the twenty cages 3 appear to be perfectly smooth in all their surfaces and exposed edges and without loose fibers.

Two different speed tests are carried out on the sixty cages, comparing the behavior of the tumbled cages with that one of the untumbled cages.

The results are reported in the following Table 1, wherein the composite material cages in epoxy resin and carbon fibers are indicated as EPYCA and wherein the test parameters are also reported. “Y” means presence of rattling or clicking, “N” means no noise at all.

TABLE 1

| | | Cage Rattling | | |
|---|---|---|---|---|
| | | EPYCA | EPYCA | EPYCA |
| ID | Speed | Untumbled | Untumbled | Tumbled |
| SV3i1 | Ramp 3.5 min to | Y | Y | Y |
| | 1600 rpm | | | |
| SSTi1 | Steps 30 s × | Y | N | N |
| | 2000 rpm | | | |
| | to 16000 rpm | | | |
| SSTi2 | Steps 30 s × | Y | y | N |
| | 2000 rpm | | | |
| | to 16000 rpm | | | |
| SV3i2 | Ramp 3.5 min to | Y | N | N |
| | 1600 rpm | | | |
| SSTi3 | Steps 30 s × | y | Y | N |
| | 2000 rpm | | | |
| | to 16000 rpm | | | |
| SSTi4 | Steps 30 s × | N | N | N |
| | 2000 rpm | | | |
| | to 16000 rpm | | | |

As it may be seen, in only one experiment the tumbled cages have produced a (limited) rattling, which was no more present in a second test carried out under the same test parameters. The tumbled epoxy/carbon fiber cages displayed almost no rattling. It has been demonstrated, therefore, that carrying out tumbling on the epoxy/carbon fires cages has a positive impact on the rattling performance of the cage.

Tumbling (and subsequent washing operation) after machining (e.g., for separating by cutting the segments 18 from the preform tube 12 and providing the holes forming the pockets or seat 8) were observed to eliminate or at least mitigate carbon fiber layer possible delamination in the cage and reducing generation of loose particles at the inside of the rolling bearing equipped with such cages.

Therefore, tumbling stabilizes the cage surface and prevents grease contamination by loose fibers and/or particles in operation. The performance of tumbled epoxy/carbon fiber cages was one of the best observed among fiber reinforced polymer cages.

Advantages of the combination: tumbling epoxy/carbon fiber cages are as follows: stabilization of cage surface, removal of burrs/fibers due to post machining, removal of surface imperfections, mitigation of delamination of carbon fiber layers on the outer and inner diameter and in cage pockets, reduction in generation of particles during operation, prevention of grease contamination, elimination of undesired noise. All the aims of the disclosure are therefore achieved.

What is claimed is:

1. A low noise composite material rolling bearing cage formed by a method comprising:
providing an annular body having a plurality of through openings each configured to receive a rolling body, the annular body comprising epoxy resin and a plurality of embedded and superimposed layers of continuous reinforcing fibers in the epoxy resin, the epoxy resin having a glass transition temperature greater than or equal to 90° C., and
subjecting the annular body of epoxy resin to a burr-removing tumbling operation.

2. The composite material rolling bearing cage according to claim 1,
wherein the glass transition temperature of the epoxy resin is about 120° C.

3. The composite material rolling bearing cage according to claim 1,
wherein the reinforcing fibers are chosen from the group consisting of: carbon fibers, glass fibers, Kevlar® fibers, basalt fibers, quartz fibers, Al₂O₃ fibers, SiC fibers, steel fibers, aluminum fibers, cotton fibers, cellulose fibers, flax fibers, jute fibers, hemp fibers and sisal fibers.

4. A rolling bearing comprising:
an outer ring,
an inner ring,
a composite material rolling bearing cage according to claim 1 between the inner ring and the outer ring, and
one of the rolling bodies in each of the plurality of through-openings.

5. A method for producing at least one low noise composite material rolling bearing cage comprising:
providing at least one an annular body having a plurality of through openings each configured to receive a rolling body, the at least one annular body comprising epoxy resin and a plurality of embedded and superimposed layers of continuous reinforcing fibers in the epoxy resin, the epoxy resin having a glass transition temperature greater than or equal to 90° C., and
subjecting the at least one annular body of epoxy resin to a burr-removing tumbling operation.

6. The method according to claim 5,
wherein the providing includes:
a) producing a preform tube made of the epoxy resin and plurality of embedded and superimposed layers of continuous reinforcing fibers,
b) curing the preform tube, and
c) radially cutting the at least one annular body from the preform tube

7. The method according to claim 5,
wherein the reinforcing fibers are selected from the group consisting of: carbon fibers, glass fibers, Kevlar® fibers, basalt fibers, quartz fibers, Al₂O₃ fibers, SiC fibers, steel fibers, aluminum fibers, cotton fibers, cellulose fibers, flax fibers, jute fibers, hemp fibers and sisal fibers.

8. The method according to claim 5,
wherein the burr removing tumbling operation comprises:
loading the at least one annular body into a vibrating tumbler machine, and
loading abrasive particles having a dimension of at least one order of magnitude lower than an outer diameter of the at least one annular body into the vibrating tumbling machine.
